(19) United States
(12) Patent Application Publication
(10) Pub. No.: US 2023/0364660 A1
(43) Pub. Date: Nov. 16, 2023

(54) CONTROL OF SOIL CONTAMINANT MASS DISCHARGE WITH HORIZONTAL PERMEABLE COLLOIDAL SORBENT BARRIERS

(71) Applicant: Regenesis Bioremediation Products, San Clemente, CA (US)

(72) Inventors: Kristen A. Thoreson, San Clemente, CA (US); Paul R. Erickson, San Clemente, CA (US); Steve Barnes, San Clemente, CA (US); Yen-Ling Liu, San Clemente, CA (US)

(21) Appl. No.: 18/143,537

(22) Filed: May 4, 2023

Related U.S. Application Data
(60) Provisional application No. 63/341,494, filed on May 13, 2022.

(51) Int. Cl. B09C 1/08; B01J 20/20; B01J 20/28; E02D 31/00; B09C 1/10

(52) U.S. Cl. CPC B09C 1/08; B01J 20/20; B01J 20/28016; B01J 20/28004; E02D 31/004; B09C 1/10; B09C 2101/00

(57) ABSTRACT

Methods of treating soil contained in a volume of treatment in an underground site and forming a containment barrier within an underground site are contemplated herein. A treatment methodology may be administered upon soil having previously been contained in the volume of treatment. Such a treatment methodology may include the application of an adsorbent to this soil. A layer of micron-sized adsorbents may also be placed on one or more interfaces surrounding the volume of treatment to form a containment barrier operative to mitigate diffusion of contaminants into or from the volume of treatment. Soil in the volume of treatment may be removed to allow for the methods contemplated herein to be performed more simply and effectively. The volume of treatment may then be refilled with a filler.

### CROSS-REFERENCE TO RELATED APPLICATIONS

This application relates to and claims the benefit of U.S. Provisional Application No. 63/341,494 filed May 13, 2022, and entitled “IMPROVED CONTROL OF SOIL CONTAMINANT MASS DISCHARGE WITH HORIZONTAL PERMEABLE COLLOIDAL SORBENT BARRIERS,” the entire disclosure of which is hereby wholly incorporated by reference.

### STATEMENT RE: FEDERALLY SPONSORED RESEARCH/DEVELOPMENT

Not Applicable

### BACKGROUND

### 1. Technical Field

The present disclosure generally relates to the field of treatment of contaminated soils. More particularly, the present disclosure relates to the treatment of soils and forming contaminant barriers in an underground site from which the soils may be temporarily removed.

### 2. Related Art

The soils on land impacted by chemical contamination, including petroleum hydrocarbons, herbicides, pesticides, halogenated hydrocarbons, halogenated dibenzodioxins, polychlorinated biphenyls (PCBs), per- and polyfluoroalkyl substances (PFAS), often require treatment or proper management to protect the environment and rehabilitate areas for future beneficial use. A variety of management and treatment techniques for contaminated soils are available, and the best suited method of remediation depends on a variety of site-specific variables. In some situations, soil may be best managed by removal and transport to an offsite location, either a landfill or specialized facility for further treatment. When appropriate, contaminated soils may be treated on-site using methods to remove the contamination by washing, soil grain sorting, or, for some particular types of contaminants, thermally or chemically destructive methods. In these cases, the contaminant mass is either degraded in place or removed from the soil for further treatment or disposal. Biological soil treatment is another possibility for many organic contaminants that are susceptible to biodegradation and some metals that can be transformed to less toxic or mobile forms.

Another common method of managing contaminated soils is to stabilize the contaminants and/or solidify the soils using a site-specific mixture of amendments which aid in chemically immobilizing the contaminants present and cementing the soils into a consolidated state. This approach, known as soil stabilization/solidification (S/S) aims to reduce the risk posed by soil contamination by drastically reducing or eliminating the contaminant mass discharging (leaching) from the contaminated soils following treatment. S/S is widely used to remediate soil impacted by heavy metals and organic contaminants that are highly resistant to chemical and biological treatment. Soils treated by S/S become significantly less likely to leach contaminant mass into the surrounding environment, but even if this approach is implemented properly, the leaching of such contaminants are rarely eliminated entirely. For contaminants with stringent cleanup targets and/or less responsive to S/S, this remaining contaminant leachability can compromise the success of a S/S remedial approach. Some level of leaching from soils typically remains even after treatment. What is needed to address these issues are methods and techniques to further ensure contaminant mass remains within a treatment area and does not discharge to the surrounding environment.

### BRIEF SUMMARY

To solve these and other problems, a treatment of an underground site is contemplated wherein a target area and volume of soil, referred to hereinafter as a volume of treatment, is identified and thereafter wholly or partially treated by administering a treatment methodology upon such soil. Such a treatment methodology may be administered upon the soil in situ or to the soil following excavation thereof and may also be proactively administered upon such soil in anticipation of potential future contamination. Additionally, treatment of an underground site is contemplated whereby a layer of micron-sized adsorbents may be placed on least a portion of one or more interfaces defining the volume of treatment, namely, one or more of the boundaries between soil contained in the volume of treatment and surrounding soil. The effects of the treatment methodology and micron-sized adsorbents, either alone or in combination, may operatively form a containment barrier that is operative to substantially mitigate the diffusion of contaminants in the underground site, especially in relation to the interface surrounding the volume of treatment.

With respect to the administration of a treatment methodology upon the soil, at least a portion of soil may remain contained and/or treated within the volume of treatment.

Alternatively or in addition to in situ treatment of the soil, a treatment methodology may be administered upon the soil by removing at least some soil from the volume of treatment, the soil removed from the volume of treatment defining excavated soil, and thereafter administering the treatment methodology upon all or a portion of the excavated soil. Following the administration of this treatment methodology upon the excavated soil, the method may further comprise the step of at least partially refilling the volume of treatment with the treated excavated soil. Alternatively, or additionally, to the extent a quantity of soil is removed from the volume of treatment, the method may further comprise the step of at least partially refilling the volume of treatment with a filler, wherein the filler may be selected from the excavated soil, other soils, filling materials, or combinations thereof.

All or a portion of the soil comprising the volume of treatment may contain one or more contaminants, the one or more contaminants being selected from: petroleum hydrocarbons, herbicides, pesticides, halogenated hydrocarbons, halogenated dibenzodioxins, polychlorinated biphenyls, per- and polyfluoroalkyl substances, or combinations thereof.

The treatment methodology administered upon the at least a portion of soil may comprise the application of a treatment additive selected from an adsorbent, a permeability modifier, a chemical species, a processing agent, a microorganism, or combinations thereof. Alternatively, or additionally, the treatment methodology may include one or more other types of treatment methods, including thermal desorption, thermal destruction, sonolysis, photocatalysis, soil washing, soil rinsing, soil flushing, soil ball milling, or combinations thereof. Such treatment methodologies may be operative to treat the soil by affecting contaminants found in the soil the treatment methodology is performed upon and/or contaminants otherwise present in the underground site. The mechanisms by which these treatment methodologies may affect those contaminants include mitigating the diffusion of the contaminants, mitigating the leachability of the contaminants, degrading the contaminants, reducing the mass of the contaminants, separating the contaminants from the soil, isolating the contaminants from the soil, or combinations thereof.

If adsorbents are to be applied to the soil as part of the treatment methodology, the cumulative weight of the adsorbents to be applied may range from 0.01-25% of the soil weight of the soil to be treated; these adsorbents could be selected from activated carbon, modified clay minerals, ionic exchange resins, cyclodextrin polymers, zeolites, and combinations thereof.

The permeability modifier applied to the soil in certain embodiments of the treatment methodologies may be operative to reduce the soil's permeability via solidification of the soil. Such permeability modifier may be selected from: Portland cement, hydrated lime, cement kiln dust, lime kiln dust, fly ash, bottom ash, magnesium oxide, or combinations thereof. The cumulative weight of the permeability modifier applied to the soil may range from 0.01-25% of the soil weight of such soil.

The application of the chemical species which the treatment methodology could comprise may be operative to chemically degrade one or more contaminants that could be present in the soil. The chemical degradation of one or more contaminants may operate by a reductive process and/or by an oxidative process. Exemplary chemical species may include and can be selected from: hydrogen peroxide, sodium persulfate, potassium permanganate, sodium percarbonate, zero valent iron, zero valent zinc, or combinations thereof.

The microorganism may be operative to biologically degrade one or more of the contaminants that could be present in the soil. The microorganism may be introduced from outside the underground site. The microorganism could alternatively be naturally present in the underground site. More than one type of microorganism may be applied to the soil.

The processing agent may comprise water, sand, gravel, clays, or combinations thereof. Such processing agents may enhance the distribution of other treatment additives applied to the soil, ease the handling/excavation of the soil, minimize the spread of dust and/or particulates to the surrounding environment, and combinations thereof.

In an alternative embodiment of the methods contemplated herein, there is further provided a method of establishing a micron-scale adsorbent barrier at an interface defining a boundary between the soil contained in the volume of treatment and surrounding soil. This method may comprise a step of emplacing a layer of micron-sized adsorbents on at least a portion of the interface. To that end, the micron-sized adsorbents can be formulated as a suspension of the micron-sized adsorbents when emplaced upon at least a portion of the interface whereby the micron-sized adsorbents can range from 0.001-69% by weight of solid component of such suspension. The emplacement step may be performed via spraying, auger mixing, injection, or combinations thereof such that the layer of micron-sized adsorbents form a layer having a thickness ranging from 0.001-100 kg/m2.

The micron-sized adsorbents may be selected from: activated carbon, modified clay minerals, ionic exchange resins, cyclodextrin polymers, zeolites, or combinations thereof and likewise may be less than 20 microns in diameter. In a more highly preferred embodiment, the particles of the micron-sized adsorbents may have a D90 value of 10 microns or less and in a most-preferred embodiment the particles of the micron-sized adsorbents may have a D90 value of 3 microns or less.

The method may further comprise a step of applying adsorbents to at least a portion of soil contained in the volume of treatment such that at least a portion of the adsorbents are placed on at least a portion of the interface. In a preferred embodiment, soil within or surrounding the volume of treatment is removed by excavation to facilitate the performance of the steps of applying adsorbents to the soil and/or placing of micron-sized adsorbents at the volume of treatment interfaces in order to give more effectual results, especially to the extent the excavated soil having adsorbents applied thereto is used to refill the site of excavation. At least some of the micron-sized adsorbents and at least some of the adsorbents may be emplaced at the same portion of the interface adsorbent barrier to cooperatively define a boundary between the soil contained in the volume of treatment and surrounding soil.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a depiction of the emplacing of the micron-sized adsorbents on the interfaces of a volume of treatment, with the soil previously contained in the volume of treatment previously being removed;

FIG. 2 is an illustration of the refilling step of refilling the volume of treatment with the excavated soil alongside additives; and

FIG. 3 and FIG. 4 are the results of an experiment comparing a treatment method contemplated herein with alternative test cells.

Common reference numerals are used throughout the drawings and the detailed description to indicate the same elements.

### DETAILED DESCRIPTION

The detailed description set forth below is intended as a description of the presently preferred embodiment of the invention, and it is not intended to represent the only form in which the present invention may be implemented or performed. The description sets forth the functions and sequences of steps for practicing the invention. It is to be understood, however, that the same or equivalent functions and sequences may be accomplished by different embodiments and that they are also intended to be encompassed within the scope of the invention.

Disclosed herein are methods for treating soils and forming contaminant barriers to contain and inhibit the mitigation of contaminants present in soil within an underground site. To that end, the invention contemplates identifying the metes and bounds of a target area of land and thereafter dimensionally determining the shape and volume of soil at an underground site, referred to as a volume of treatment, to which the methods of the present invention will be directed.

The target area may comprise the above ground land area, below which the contaminants may be found or may later in the future be found to a discernable depth. This step of determining the metes and bounds of the volume of treatment may comprise the usage of conventional methods known in the art to identify and quantify the contaminants present in the ground below and/or associated with the target area; this step may comprise ascertaining the susceptibility of the ground below and/or associated with the area to become contaminated or experience an increase in contamination in the future. As such, the disclosed methods may be utilized to treat underground sites already containing contaminated species of which it is desirable to mitigate the diffusion of, to treat underground sites that may in the future become contaminated, and/or to treat underground sites that may experience an increase in contamination in the future. This determining step may be based on environmental regulations set by a governmental authority (for example, comparing the amount of a contaminated species present in the underground site with the amount that an environmental guideline considers unsafe). The contaminants to be treated may include, but are not limited to, petroleum hydrocarbons, herbicides, pesticides, halogenated hydrocarbons, halogenated dibenzodioxins, polychlorinated biphenyls (PCBs), per- and polyfluoroalkyl substances (PFAS), or combinations thereof. The underground site to be treated may comprise the ground, soil, and other species that may be found underground. As such, the underground site may comprise soils at least 0.1 meters below the ground surface and encompass both soil within the volume of treatment and soil outside the volume of treatment.

When determining the volume of bulk treatment, one may consider additional factors about the underground site and the soil therein. For example, this determining step may utilize conventional techniques used to evaluate soil, such as identifying soil type (type A, type B, type C) and soil composition. This information can guide someone to utilize certain excavation methods and/or particular embodiments of the treatment procedures discussed herein that are suited for a particular underground site and the associated soil, which would be understood and appreciated by those skilled in the art. It may additionally be necessary to consider features around the target area and found within the underground site such as aquifers and the underground components of nearby buildings (piping, for instance) which could be affected by excavation. As such, those skilled in the art would understand how to properly shape and mold the volume of treatment such that an effective treatment procedure may be carried out with minimal damages and changes to the underground site and the surrounding environment.

Once the volume of treatment in the underground site is defined, one skilled in the art may then assess the treatment procedures disclosed herein to identify and determine the quantity and depth of soil to which a treatment methodology may be administered upon, and optionally the soil to be removed, and/or where and how extensive the containment barrier may be formed or otherwise established. Soil may be contained in the volume of treatment, and a portion of this soil may be treated in subsequent steps discussed herein. Any type of soil may be treated in the methods disclosed herein, including soil free of contaminants, soil already containing contaminants, soil that hasn't received any form of treatment, and soil that has already had some form of a treatment administered upon on it. If it is this last case, the disclosed methods may help to enforce a differing treatment method already in place in the underground site and/or reinforce a treatment methodology disclosed herein that has already been carried out. As such, the methods contemplated herein may be performed multiple times on the same underground site or on the same volume of treatment.

To that end, the target soil to be treated per the present invention may comprise all or a portion of soil within the volume of treatment. The present invention may additionally comprise the treating of the interfaces defining one or more boundaries between the soil contained in the volume of treatment and surrounding soil. A treatment methodology may be administered upon at least a portion of soil contained in the volume of treatment whereby such a methodology may be operative to affect contaminants that may be present in the soil and/or contaminants that may later in the future be introduced or otherwise attempt to diffuse through the soil. The treatment methodologies may affect the contaminants via one or more mechanisms including mitigating the diffusion of the contaminants, mitigating the leachability of the contaminants, degrading the contaminants, reducing the mass of the contaminants, separating the contaminants from the soil, isolating the contaminants from the soil, or combinations thereof. Alternatively or in addition to the administration of a treatment methodology, a layer of micron-sized adsorbents may be placed on at least a portion of the one or more interfaces whereby such emplacement may form/establish a containment barrier operative to mitigate the diffusion of contaminants already present or already near the underground site, or to mitigate the diffusion of contaminants that may later be introduced to the underground site or otherwise attempt to diffuse through the underground site. Treatment additives applied to soil previously contained in the volume of treatment via the treatment methodology (to be described later herein), such as adsorbents, may also help to form/establish this containment barrier. In this regard, it is contemplated that the present invention is operative to produce a containment barrier by action of the micron-sized adsorbents applied to the interface about the volume of treatment, adsorbents applied to the soil within the volume of treatment, or a combination thereof. In all cases, the containment barrier may substantially mitigate or almost completely mitigate the migration of contaminants in and/or near the volume of treatment.

According to a first aspect of the present invention, at least a portion of the soil contained in the volume of treatment may be treated via a treatment methodology. The treatment methodology may at least partially comprise the application of one or more treatment additives to the soil. The treatment methodology may alternatively, or additionally, comprise other forms of treatment to be administered upon the soil, which will be detailed later in the disclosure herein. Since this treatment procedure may be administered upon soil that was at some point previously contained in the volume of treatment, the treatment methodology may be administered upon soil that has been removed from the volume (to be described later herein), upon soil remaining contained within the volume of treatment, or a combination thereof (some of the soil in the volume being removed and treated outside of the volume while some of the rest of the soil in the volume is treated without removal from the volume). In this last example, the volume of treatment may be divided into sections of soil to be removed and sections of soil to remain in the volume of treatment.

At least a portion of the soil in the volume of treatment may be given this treatment methodology, and in some cases the results of the treatment methodology may be the same or nearly the same when certain regions of soil contained in the volume of treatment are treated versus when those regions are not treated. This may arise when, for example, a region of soil is given the treatment methodology that encompasses a region of soil that does not receive this treatment methodology (since the treatment of the outer region may prevent contaminants from being able to diffuse into the encompassed region). Additionally, certain segments of the soil to be treated can have different types of treatment methodologies administered upon them. As an example, one segment of soil can have just treatment additive A applied to it, while another segment can have just treatment additive B applied to it, while a third segment can have both treatment additives A and B applied to it.

The portion of the soil to be given the treatment methodology may cumulatively have a soil weight, knowledge of which may prove to be useful in determining the amount of treatment additives to use (as will be described later). Those skilled in the art would understand how to calculate the approximate total weight of a given amount of soil (soil weight), which may be calculated via using information about the previously mentioned properties of the soil such as the composition and type of soil. One may also calculate the soil weight by utilizing the value of a given volume of soil with that of the density of the soil, which may be derived from a portion of that volume of soil. Additionally, or alternatively, one may use existing books/manuals/information that provide the soil density values of certain types and compositions of soil/soil found in certain geographical regions. The weight of soil may also be calculated by more direct methods, such as weighing excavated soil and using weight measuring devices in excavation machines to name a few examples.

In certain embodiments, the treatment methodology may comprise the application and/or mixing of one or more treatment additives to the soil. Such techniques may be akin to conventional soil stabilization and solidification methods. Each of these treatment additives may be applied to/mixed with the soil simultaneously with each other, or these treatment additives may each be applied/mixed after and/or before one another or a combination thereof (some of treatment additive A is added before treatment additive B is added and some after treatment additive B is added). As such, it can be seen there are several different combinations in the order in which the number of treatment additives used can be independently and/or simultaneously applied to and/or mixed with the soil. Each of these treatment additives may be applied to and/or mixed with soil previously being contained in the volume of treatment (either while soil is still contained in the volume of treatment or after soil is removed from the volume of treatment). The treatment additives may be applied to and/or mixed with the soil gradually over a given length of time until the desired amount of the component has been applied to and/or mixed with the soil.

One type of treatment additive that may be ideally used in the methods disclosed herein are adsorbents. It has been found that this type of treatment methodology has given effective and desirable results when the cumulative weight of the adsorbents being applied to and/or mixed with a given amount of soil ranges from 0.01-25% of the soil weight. In more ideal embodiments, the cumulative weight of the adsorbents may range from 0.1-15% of the soil weight. In even more ideal embodiments, the cumulative weight of the adsorbents may range from 1-10% of the soil weight. The adsorbent material may include, but it is not strictly limited to, activated carbon, modified clay minerals, ionic exchange resins, cyclodextrin polymers, zeolites, and combinations thereof. These adsorbents may be operative to immobilize the majority of contaminants present in the soil and underground site and/or contaminants that may later be introduced to the soil and underground site in one form or another. The function of these adsorbents may be largely identical to that of the micron-sized to be discussed later herein, but the particle size of these adsorbents may often be, but must not always be, larger than that of the micron-sized adsorbents.

Adsorbents need not be the only type of treatment additive applied to/mixed with the soil. In fact, various other treatment additives may be used alone or in combination with each other and/or the adsorbents. One of these treatment additives that may be applied to and/or mixed in the soil is a permeability modifier which may serve to reduce the permeability of the soil. Once the permeability modifier is applied and/or mixed, water infiltration through the soil may be reduced, which may further hamper the migration of the contaminants through the soil. The permeability modifier may be applied to and/or mixed with a given amount of soil such that the cumulative weight of the permeability modifier added is 0.01-25% of the soil weight of the given portion of soil. In more ideal embodiments, the cumulative weight of permeability modifier may be 0.1-15% of the soil weight. In even more ideal embodiments, the cumulative weight of the permeability modifier may be 1-10% of the soil weight. The permeability modifier may comprise cementitious agents and pozzolans, which may include, but is not limited to, Portland cement, hydrated lime, cement kiln dust, lime kiln dust, fly ash, bottom ash, magnesium oxide, or combinations thereof.

Processing agents are another class of treatment additives that may be applied to and/or mixed with the soil. Processing agents may serve to enhance distribution of the other treatment additives applied to/mixed with the soil, enhance the contact between the soil and the other treatment additives applied to/mixed with the soil, ease the handling/excavation of the soil, minimize the spread of dust and/or particulates to the surrounding environment, and combinations thereof. These processing agents may include, but are not strictly limited to, water, sand, gravel, clays, and combinations thereof. There are several more processing agents that may be utilized that are commonly used in soil stabilization and solidification, which those in the art would understand could be used in the methods disclosed herein. The processing agent may be mixed with and/or applied to a given amount of soil such that the cumulative weight of the processing agent ranges from 0.01-25% of the soil weight of the given amount of soil. In more ideal embodiments, the cumulative weight processing agent is 0.1-15% of the soil weight. In even more ideal embodiments, the cumulative weight of the processing agent is 1-10% of the soil weight.

Another type of treatment additive that may be applied to and/or mixed with at least a portion of the soil is a chemical species. The chemical species may comprise a chemical oxidant, a chemical reductant, or combinations thereof. The chemical oxidant may include, but it is not strictly limited to, hydrogen peroxide, sodium persulfate, potassium permanganate, sodium percarbonate, and combinations thereof. The chemical reductant may include, but is not strictly limited to, zero valent iron, zero valent zinc, or combinations thereof. Those skilled in the art would also recognize additional chemical oxidants and chemical reductants that can be effectively utilized in the presently disclosed methods. The chemical species may be applied to and/or mixed with a given amount of soil such that the cumulative weight of the chemical species is 0.1-10% of the soil weight of the given amount of soil. In more ideal embodiments, the cumulative weight of the chemical species is 1-5% of the soil weight. These chemical species may serve to chemically degrade contaminants that may be present in the soil or would later be introduced to the soil in one form or another.

Yet another type of treatment additive that is viable to be applied to/mixed with the soil is a microorganism operative to degrade one or more of the contaminants that could be present in the soil. The microorganisms may be introduced from outside of the underground site, whether they be naturally occurring organisms found elsewhere or a synthetically produced microorganism. One skilled in the art would recognize how to properly determine and select a microorganism so as to target particular types of contaminants present/susceptible to being present in the underground site. As such, they could turn to existing data provided in manuals/textbooks/literature/online databases that are known to be effective at degrading a contaminant within the conditions of the soil, e.g., pH, redox potential, oxygen content, nutrient availability. They could also first perform a test on a sub-sample of the soil to better understand the types of microorganisms that could be effective for that particular underground site. Alternatively, the microorganisms may also be naturally present in the soil. More than one type of microorganism can be applied to/mixed with the soil as part of the same treatment methodology.

The treatment additive(s) may be mixed with and/or applied to at least a portion of the soil via a number of methods, such as mechanical soil tilling, bucket mixing, auger mixing, specialty soil mixing tools, or combinations thereof. Since the soil need not be removed from the volume of treatment when applying the treatment additive(s), certain application/mixing methods may be more effective than others. For example, soil deep underground may require the use of auger mixing in order to effectively apply and mix the treatment additive(s). For a given number of treatment additives being applied to and/or mixed with the soil, each of the treatment additives may be applied to and/or mixed with the soil using the same method, two or more of the treatment additives may be applied and/or mixed using the same method that differs from another treatment additive, or each treatment additive may be applied and/or via a different method from each other.

The treatment methodology may alternatively or additionally comprise other forms of treatment which may be used alone or in combination with each other. Each of these treatment methodologies may be modified and configured similar to that of the application of a treatment additive in that the order and number of techniques utilized can be switched around and changed as desired.

Thermal treatment is one example of an effective form of treatment; this thermal treatment may manifest itself in different a couple of ways. Thermal desorption is one such thermal treatment that is envisaged, wherein the soil is heated in a manner (typically via thermal conductive heating, electrical resistance heating, hot air injection, steam injection, or infrared heating, although any means of heating can be utilized) that raises the temperature so as to release contaminants from the soil. Once released from the soil, the contaminants can be captured in numerous ways such as soil vapor extraction, thereby leaving behind soil with a lower concentration of contaminants. The appropriate temperature will vary depending on the volatility of the specific contaminants but typically ranges between 100° C. and 1,000° C. Another form of thermal treatment contemplated is thermal destructive processes in which a high temperature (which can be produced via heating methods similar to those listed above) induces a destructive mechanism for contaminants resulting from pyrolysis, thermolysis, or combustion. Thermal destructive processes will also vary by contaminant but typically range between 400° C. and 1,500° C.

Additional viable forms of treatment could include soil washing, soil rinsing, soil flushing, and combinations thereof, wherein the soils with contaminants are washed with a liquid designed to extract the contaminants (e.g., surfactants, acidic or basic solutions, reducing agents, chelating agents) from the soil and/or wherein the finer-grained soils that contain higher concentrations of contaminants are physically separated from the larger soil particles using a liquid treatment followed by a technique such as wet screening, hydrodynamic separation, gravity separation, or combinations thereof. In either case, these treatments result in a removal of contaminants from the bulk soil, leaving behind soil with an overall lower contaminant concentration.

Mechanochemical procedures, such as soil ball milling, provide another form of treatment that is operative to destroy contaminants that are adhered to soils. In this method, contaminated soils may be introduced into a milling apparatus (e.g., a ball mill) where the grinding, shearing, and other physical stressors supply energy that results in physical-chemical transformations of contaminants. Factors to be considered with this treatment methodology include rotation speed, ball to soil weight ratio, ball milling media composition, milling orientation (horizontal or planetary), and co-milling reagents. The ideal parameters may be realized through existing literature or via small-scale testing. Following this form of treatment, the soil contaminant concentrations are reduced.

A physio-chemical treatment of sonolysis may also be applied to the contaminated soil as a treatment methodology or a portion thereof. In this case, soil, often in the form of a slurry, is irradiated with ultrasonic waves resulting in destruction of at least some of the contaminants present in the soil. The ultrasonic waves are typically applied in a range of 20 to 1,000 kHz, with the ideal range being dependent on the target contaminant. Sonolysis may be applied at a single frequency, or at multiple-frequencies.

Soil decontamination via photocatalysis is also considered as a form of treatment in the present disclosure. Following this procedure, solar radiation in the presence of a photocatalyst such as titanium dioxide is used to detoxify soils, resulting in lower soil contaminant concentrations.

The above treatment methodologies act as examples of processes that can result in decreased contaminant concentrations on soil by a variety of mechanisms. Additional benefits may result from the combination of two or more of these methods. For example, a heat activated (thermal)-sodium persulfate treatment may provide a synergistic effect that provides greater efficacy than either the chemical treatment of sodium persulfate or thermal desorption alone. An additional example is sonolysis coupled with sodium persulfate, where when used together there may be a greater benefit than either used alone. It can be envisaged that other treatment methodologies that can be conducted in situ or ex situ on at least a portion of the soil could also be utilized in this invention, including those not explicitly disclosed herein. As such, it can be seen and appreciated that future treatment methodologies that have not yet been developed/discovered could be used in the methods contemplated herein without departing from their limits and scope.

Additionally, the contemplated methods of the present invention may comprise an additional step of removing at least some of soil contained in the volume of treatment. This may allow for easier and more effective administration of the treatment methodologies and/or emplacement of the layer of micron-sized adsorbents, discussed below. If such removal step is performed, another subsequent step of at least partially refilling the volume of treatment with the excavated soil may be performed, likewise discussed in more detail below. Prior to refilling the volume of treatment with the excavated soil, one of the treatment methodologies may be administered upon the excavated soil. This treated excavated soil may then be used to refill the volume of treatment at least partially. These removal and refilling steps may allow for an exceptional improvement in mitigating the diffusion of contaminants and/or otherwise treating those contaminants when used to enhance the steps of administering the treatment methodology and/or placing a layer of micron-sized adsorbents.

In a second aspect of the present invention, the methods disclosed herein may comprise a step of placing a layer of micron-sized adsorbents on at least a portion of the one or more interfaces of the volume of treatment. This treatment procedure may be referred to as a “surrounding treatment”. The micron-sized adsorbents may comprise, but they are not limited to, activated carbon, modified clay minerals, ionic exchange resins, cyclodextrin polymers, zeolites, and combinations thereof. The thickness of the layer of micron-sized adsorbents may range from 0.001-100 kg/m², in which the mass refers to the solid weight of the micron-sized adsorbent and the area refers to the square meter area upon which the layer occupies, which could be the same area or substantially the same area as at least a portion of the one or more interfaces. These micron-sized adsorbents may be operative to mitigate the diffusion of contaminants already at or near the one or more interfaces and/or they may be operative to mitigate the diffusion of contaminants that would later in the future be introduced to the one or more interfaces in one form or another. As such, a containment barrier may be formed/established by the emplacement of the layer of micron-sized adsorbents.

These micron-sized adsorbents may be distinct from the aforesaid adsorbents in that the micron-sized adsorbents may be of a particularly small size. The micron-sized adsorbents may be less than 20 microns in diameter. These types of micron-sized particles may be described by their D90 value, which, as would be understood by those skilled in the art, represents the diameter in which 90% of the particles present have a diameter less than. Ideally, the micron-sized adsorbents may have a D90 value of 10 microns or less, and even more ideally the micron-sized adsorbents may have a D90 value of 3 microns or less.

The layer of micron-sized adsorbents may be placed at the interface via application and/or mixing of a suspension of micron-sized adsorbents in a fluid. Ideally, the fluid utilized is water. The suspension may be a highly concentrated suspension of the micron-sized adsorbents, or preferably the suspension will be diluted to a range of 0.001-70% by weight of micron-sized adsorbents. Even more preferably, the suspension may be diluted to a range of 0.1-30% by weight of micron-sized adsorbents. In the most preferred embodiments, the suspension will be diluted to a range of 5-45% by weight of micron-sized adsorbents. The suspension may additionally include stabilizing agents and/or micron processing agents. Both types of agents may be in the range of 0.001-30% by weight of the suspension, or, in more preferred embodiments, 0.01-15% by weight of the suspension. Stabilizing agents may be anionic polymers, nonionic polymers, and combinations thereof, examples of which include, but are not limited to, carboxymethyl cellulose, carrageenan, polyacrylic acid, xanthan gum, and combinations thereof. The stabilizing agent may serve to stabilize the suspension, which could include preventing coagulation of the suspension through inter-particle repulsion. The micron processing agents that may be utilized include, but are not limited to, preservatives, anionic polymers, nonionic polymers, anionic surfactants, nonionic surfactants, and combinations thereof. Sodium benzoate, sodium bisulfite, lactic acid, sorbic acid, phosphoric acid, carboxylated polysaccharides, polyacrylates, polyacrylamides, lignosulfonate, polyacrylate copolymers, alkyl and aryl sulfate and alkyl carboxylates, and combinations thereof are a number of specific examples of possible micron processing agents. Like the aforementioned optional additives, the stabilizing agents and the micron processing agents may be added to the interfaces simultaneously alongside the micron-sized adsorbents, before and/or after the micron-sized adsorbents, or combinations thereof.

The layer of micron-sized adsorbents may be placed at the interface via a number of methods. These emplacement methods may include, but are not limited to, spraying onto the interfaces, mixing into the interfaces with specialized soil mixing tools, bucket mixing, auger mixing, injection, or combinations thereof. The emplacement via injection of the micron-sized adsorbents to the one or more interfaces may be done using low pressure (<100 psi) and high pressure (>100 psi) injection methods. Since the soil need not be removed from the volume of treatment when placing the layer of micron-sized adsorbents, certain application/mixing methods may be more effective and practical than others. For example, interfaces deep underground may require the use of auger mixing in order to effectively emplace the micron-sized adsorbents.

This surrounding treatment of the placement of the micron-sized adsorbents may be done alone or in combination with the administration of the treatment methodology upon the soil. If both are done in combination and the treatment methodology comprises the application of adsorbents, the adsorbents may occupy regions at or near the one or more interfaces where the micron-sized adsorbents are placed. In this case, the adsorbents may additionally form/establish the containment barrier or at least enforce the containment barrier's ability to mitigate the diffusion of contaminants. In such an embodiment, a contaminant would be confronted with both the layer of micron-sized adsorbents and the adsorbents at the interface, in addition to any additional adsorbents mixed with the soil in the volume of treatment. As would be understood and appreciated by those skilled in the art, any contaminants would not be able to migrate through or near the volume of treatment with ease. It can also be seen that if a contaminant is already present in the volume of treatment before carrying out both treatment procedures, it would be extremely challenging if not impossible for that contaminant to migrate outside of the volume of treatment.

As discussed above, according to certain embodiments of the presently disclosed methods at least a portion of soil may be removed from the ground. The area from which the soil may be removed may be associated with or be identical to the aforementioned target area. Ideally, the soil to be removed may be soil contained in the volume of treatment, although practically speaking some soil from outside of this volume may be incidentally or intentionally removed as well, but such practices should not cause any significant drawbacks when carrying out the methods disclosed herein nor the relative magnitude of their results. This soil to be removed may be at least a portion of the soil contained in the volume of treatment, but in preferred embodiments, the soil to be removed will be most or substantially all of the soil contained in the volume of treatment. Soil may be removed using conventional techniques known in the art, such as handheld tools for small scale situations (spades, shovels, hoes, etc.) and machinery for large scale situations (wheeled excavators, backhoe excavators, bulldozers, dragline excavators, trenchers, etc.).

Removing soil from the volume of treatment may allow exposure of or at least easier access to soil that may remain in the volume of treatment (such as soil that was buried deep beneath the soil that was just removed) and/or one or more interfaces extending about the volume of treatment. This could allow for the treatment procedures of administering the treatment methodology and the emplacement of the layer of micron-sized adsorbents to be carried out more effectively and more simply, since more of the soil can have treatment additives applied to/mixed with it and/or otherwise have the treatment methodology administered upon it and more of the interfaces can have the layer of micron-sized adsorbents emplaced upon it when they are exposed in this manner. Soil removed from the volume of treatment may be referred to as excavated soil. Excavated soil may be placed and collected away from or near to the volume of treatment such that the treatment procedures (a treatment methodology and surrounding treatment) may be performed. Some of the excavated soil may also be transported to a treatment facility in case it is desirous to treat a contaminant that may be present in the excavated soil in such a manner.

After removing soil from the volume of treatment, the volume of treatment may be at least partially refilled with a filler. In ideal embodiments, the volume of treatment is at least partially refilled after one or more of the treatment procedures are performed (the treatment methodology and surrounding treatment). The filler may comprise the excavated soil, other soils, filling materials, or combinations thereof. It may be desirable to maintain the geography and topography of the local environment after performing one of the methods performed herein, and as such it may be desirous to refill the volume of treatment to recreate the original topography at least partially. The other soils that may be used as the filler or a component of the filler may have previously been outside of the volume of treatment. As such, these other soils may be soil that is from the same underground site the volume of treatment is in, only that it is from another part of the underground site, the other soils may have previously been in a separate underground site, or a combination thereof. These other soils may be treated before being used to fill the volume of treatment, similar to the treatment the excavated soil may receive, as will be described shortly. The filling materials that may be used as the filler or a component of the filler may comprise sand, gravel, crushed stone, rock, shale, marginal materials, or combinations thereof, in addition to other backfill materials known in the art.

If the excavated soil is used as the filler or a component of the filler, the treatment methodology may be administered upon the excavated soil prior to the refilling step, as discussed above. Similar to the bulk treatment procedure, excavated soil may have the optional additives applied to/mixed with it as well. This excavated soil, now being treated, may be referred to as treated excavated soil. The treated excavated soil may then itself be used as the filler or a component thereof to refill the volume of treatment at least partially. As such, the treated excavated soil will be much more effective at mitigating the diffusion of contaminants found in or surrounding the soil. The step of excavating allows for the treatment methodology to be administered upon the excavated soil much more efficiently and for such treatment to be more potent since it would be much more challenging, if not near impossible, to carry out certain treatment methodologies such as the application of a treatment additive to certain portions soil while such soil is underground and thus harder to access. Additionally, removing soil from the volume of treatment and using that same soil to refill the volume of treatment may cause minimal changes to the local environment.

If treated excavated soil is utilized to refill the volume of treatment in this manner, and if the surrounding treatment is carried out, the containment barrier formed/established by these methodologies may become even more effective at containing and mitigating the diffusion of contaminants. Removing soil allows for a greater amount of the one or more interfaces and soil to be more easily accessed, consequently allowing for more effectual and systematic placement/establishment of the layer of micron-sized adsorbents and administration of the treatment methodology; the refilling of the volume of treatment may allow for the containment barrier to be improved via any applied adsorbents occupying more of the regions at or near the portions of the one or more interfaces where the micron-sized adsorbents are placed. Such a containment barrier may give results that are much improved over conventional prior art methods of simply using soil stabilization and solidification techniques.

The above methods will be best understood with the accompanying figures, in which preferred embodiments of the methods are depicted. As such, the figures are not meant to limit the scope of the disclosed methods, but rather to better illustrate the features and intricacies of the disclosed methods.

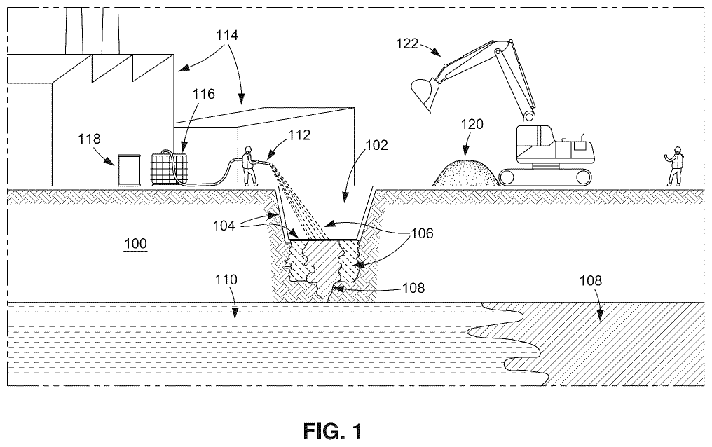

Referring now to FIG. 1, there is depicted the placing of the micron-sized adsorbents on the interfaces of a volume of treatment, with the soil previously contained in the volume of treatment previously being removed. A volume of treatment 102 in an underground site 100 is being treated to prevent the spread of contaminants 108. An aquifer 110 below the underground site 100 may contain contaminants 108 and/or may be near a source of contamination supplying contaminants 108. It can be seen that the contaminants 108 may seep into the underground site 100 through the aquifer 110. The flow of water in the aquifer 110 may cause the contaminants 108 to seep into the underground site 100 in this fashion. When determining the volume of treatment 102, one could consider the location of the aquifer 110, the types of contaminants 108 present, and surrounding structures 114. As would be understood by those skilled in the art, it may be beneficial to determine the volume of treatment 102 such that the contaminants 108 are prevented from spreading further outside of or further into the underground site 100. It additionally be desired to determine the volume of treatment 102 so as to not disturb the aquifer 110 or any underground components of the structures 114 that may be affected by the removal and placement steps.

In the embodiment shown here in FIG. 1, soil is removed from the volume of treatment 102 with an excavator 122. This soil is collected above the underground site 100 and away from the volume of treatment 102 as excavated soil 120. After this soil is removed, a layer of micron-sized adsorbents 106 may be placed/established on the interfaces 104 of the volume of treatment 102. Here, the micron-sized adsorbents 106 are supplied by a reservoir 116 containing the micron-sized adsorbents 106 before they are applied to interface 104 with a spraying tool 112. A micron additive reservoir 118 may contain stabilizing agents and/or micron processing agents, which may be added simultaneously alongside the micron-sized adsorbents 106 and/or sometime before and/or after the micron-sized adsorbents 106 are added.

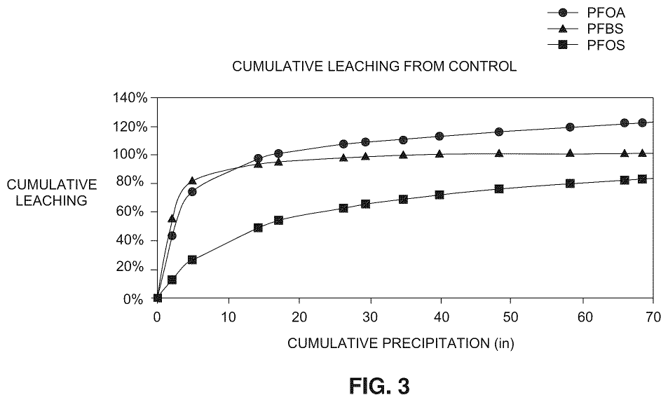

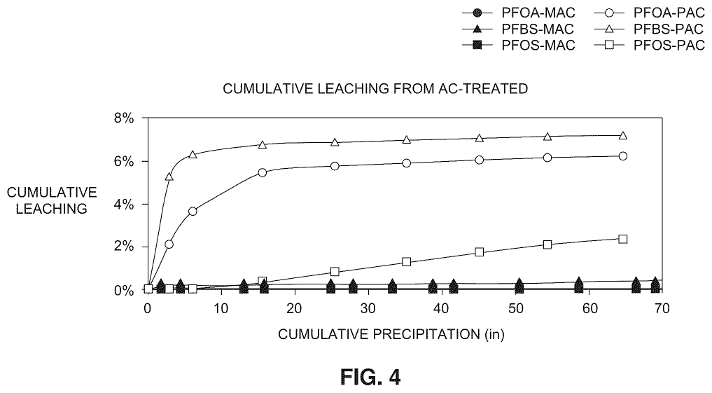

It can be seen here in this Figure that the micron-sized adsorbents 106 may leak out of the volume of treatment 102, which is an inevitable consequence of most applications of the methods contemplated herein. However, this is not a drawback of the presently contemplated methods since these micron-sized adsorbents 106 may still mitigate the diffusion of contaminants 108 in the underground site 100. Even then, the micron-sized adsorbents 106 may still form/establish a containment barrier when emplaced at the interfaces 104 of the volume of treatment 102. As will be shown in FIGS. 3 and 4, such a treatment procedure may substantially limit if not nearly eliminate any migration of contaminants 108 in the underground site 100 at or near the volume of treatment 108.

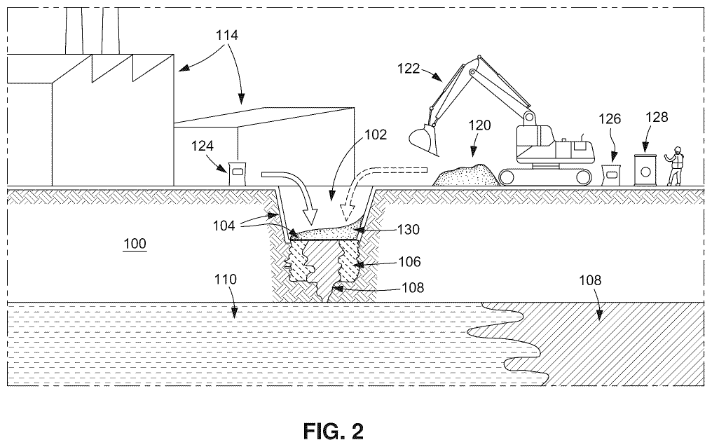

Looking now to FIG. 2, an illustration of the refilling step of refilling the volume of treatment with the excavated soil and additional fillers is shown. This particular refilling step may follow the placement step depicted in FIG. 1, but it need not be performed in conjunction with the placement step. The volume of treatment 102 is at least partially refilled with fillers. Contained soil 130 accumulating in the volume of treatment 102 may be at least partially comprised by these fillers. The fillers themselves may comprise the excavated soil 120, and other types of fillers 124 (the aforementioned other soils and/or filling materials). Before the excavated soil 120 is used to refill the volume of treatment 102, it may be treated via a treatment methodology, such as by applying/mixing adsorbents 126 to the excavated soil 120. Other treatment additives 128, which may include the previously mentioned processing agents, permeability modifiers, and/or chemical species, may additionally be applied to and/or mixed with the excavated soil 120 prior to refilling the volume of treatment 102 with the excavated soil 120, after refilling the volume of treatment 102 with the excavated soil 120, and/or before the soil is removed from the volume of treatment 102. The refilling of the volume of treatment 102 may help to maintain the local topography and aesthetics of the environment before soil was removed from the volume of treatment 102, which may be desired by people living in or working in nearby facilities 114.

In this Figure, a layer of micron-sized adsorbents 106 was placed at the interfaces 104 of the volume of treatment 102 prior to refilling the volume of treatment 102 with the excavated soil 120 and the other types of fillers 124. If the excavated soil 120 is treated with adsorbents 126 and optionally the other treatment additives 128 prior to being used to refill the volume of treatment 102, it can be seen that the contaminants 108 would have significant trouble attempting to diffuse through the following: the micron-sized adsorbents 106 that have seeped out of the volume of treatment 102, the containment barrier formed/established by the combination of micron-sized adsorbents 106 and adsorbents 126 at or near the interfaces 104, and additional adsorbents 126 which may be in the contained soil 130 in the volume of treatment 102 (if the contaminants 108 even manage to get that far past the containment barrier).

Bringing attention now to FIG. 3 and FIG. 4, the results of an experiment comparing a test cell using a treatment method contemplated herein with alternative test cells are shown. A lab-scale simulation was performed to test the ability of a layer of activated carbon (AC) to mitigate PFAS migration in the vadose zone during heavy/very heavy rain events. To demonstrate the advantage of micron-scale adsorbents on adsorbing contaminants rapidly, micron activated carbon (MAC) and powdered activated carbon (PAC) were used in this experiment. Cumulative leaching rates for activated carbon treated cells (MAC/PAC) and an untreated control cell were determined according to the following experimental setup. This test does not account for bulk treatment and instead simulates an extreme condition of highly concentrated PFAS leaching from untreated, ground surface/shallow soils through the vadose zone to a hypothetical groundwater surface.

Each test cell was filled with 900 grams (g) of site soil slightly containing PFAS. The total extracted PFAS concentration for this site soil was 25.2 nanograms per gram (ng/g). In the MAC treatment cell, 32 g of a 31.3% by weight suspension of MAC (equating to 10 g of MAC) were spray-applied evenly on the site soil. No adsorbent was applied to the control cell. In the PAC treatment cell, 10 g of PAC (same carbon weight as MAC-treated cell) were applied on top of the site soil. High concentration PFAS soil was prepared by spiking site soil with a legacy C8-based aqueous film forming foam (AFFF) concentrate. The total extracted PFAS concentration was 14,554-25,107 ng/g, approximately 600-1,000 times more highly concentrated than the native site soil. 100 g of the spiked soil was added to the top of the control, MAC treated, and PAC treated cells. Approximately one centimeter (cm) of coarse silica sand was placed on top of the spiked soil for these three tests to ensure the simulated rainwater feed was distributed evenly across the soil during precipitation. Synthetic Precipitation Leaching Procedure (SPLP) solution (pH=5, per EPA SW846 Method 1312 established protocol) was applied to each test cell at a rate of approximately 8.5 mm/hour, for two-hour intervals, at a frequency of three times weekly. The total simulated rainfall for the test duration was 65-70 inches. This experimental setup is illustrated in the chart below.

| | | Micron- | |
|---|---|---|---|
| | | Scale AC | PAC |
| TEST CELL | Control | Treated | Treated |
| SITE SOIL | 900 g | 900 g | 900 g |
| | (having | (having | (having |
| | 25.2 ng of | 25.2 ng of | 25.2 ng of |
| | PFAS/g of soil) | PFAS/g of soil) | PFAS/g of soil) |
| ADSORBENT | None | 10 g MAC | 10 g PAC |
| AFFF-SOIL | 100 g | 100 g | 100 g |
| (SPIKED SOIL) | (having | (having | (having |
| | 14,554- | 14,554- | 14,554- |
| | 25,107 ng | 25,107 ng | 25,107 ng |
| | of PFAS/g | of PFAS/g | of PFAS/g |
| | of soil) | of soil) | of soil) |
| COARSE SILICA | 1 cm | 1 cm | 1 cm |
| SPLP | 8.5 mm | 8.5 mm | 8.5 mm |
| SOLUTION | applied/hr | applied/hr | applied/hr |

Samples were collected and analyzed for PFAS periodically from the effluent leaching beneath each test cell. All effluent samples were sent for PFAS analysis per EPA 537 LC/MS/MS Method. Sample results were plotted for the three test cells comparing cumulative leaching percentage from the spiked soil cells vs. cumulative precipitation in FIGS. 3 and 4. The leaching percentages of perfluorooctanoic acid (PFOA), perfluorobutane sulfonic acid (PFBS), and peffluorooctane sulfonic acid (PFOS) from AFFF-spiked soil during heavy/very heavy rain events are shown on FIGS. 3 and 4 as PFOA, PFBS, and PFOS.

In FIG. 3, in the control test cell (without AC treatment), the cumulative leaching of PFOA and PFBS from control cell reached about 100% at 70-inch cumulative precipitation. Approximately 80% of PFOS leached out cumulatively during the heavy/very heavy rain events. This indicates that untreated, naturally occurring soils encountered at most sites will readily leach PFAS when exposed to precipitation.

In FIG. 4, it can be seen that a layer of AC, either MAC or PAC, cumulative leaching percentages of PFOA, PFBS, and PFOS reduced to below 10% after 70-inch cumulative precipitation. After 70-inch cumulative precipitation, the cumulative leaching percentages of PFOA, PFBS, and PFOS from the PAC-treated cell were 6.3%, 7.2%, and 2.4%, respectively. With micron-scale size, PFOA, PFBS, and PFOS leachability reduced to 0.1%, 0.4%, and 0.03%, respectively, from the MAC-treated cell. This demonstrates that AC with micron size successfully retained almost all PFAS mass in the vadose zone during the simulated extreme conditions because the leaching PFAS could be adsorbed to the micron-scale adsorbents more rapidly.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method of treating soil contained in a volume of treatment in an underground site and forming a containment barrier within the underground site, the method comprising the steps of:
a. administering a treatment methodology upon at least a portion of soil previously being contained in the volume of treatment, the at least a portion of soil cumulatively having a soil weight; and
b. placing a layer of micron-sized adsorbents on at least a portion of at least one interface defining the volume of treatment, the at least one interface further defining at least one boundary between soil contained in the volume of treatment and surrounding soil.

2. The method of claim 1, wherein during the step of administering the treatment methodology, some of the at least a portion of soil remains contained in the volume of treatment.

3. The method of claim 1, the method further comprising a step of removing at least some soil from the volume of treatment, the soil removed from the volume of treatment defining excavated soil.

4. The method of claim 3, wherein some of the at least a portion of soil that the treatment methodology is administered upon are at least a portion of the excavated soil, the administering of the treatment methodology upon the at least a portion of the excavated soil defining treated excavated soil, and wherein after the removing step the method further comprises a step of at least partially refilling the volume of treatment with the treated excavated soil.

5. The method of claim 3, wherein after the removing step, the method further comprises a step of at least partially refilling the volume of treatment with a filler, the filler being selected from: the excavated soil, other soils, filling materials, or combinations thereof.

6. The method of claim 1, wherein the at least a portion of soil contains one or more contaminants, the one or more contaminants being selected from: petroleum hydrocarbons, herbicides, pesticides, halogenated hydrocarbons, halogenated dibenzodioxins, polychlorinated biphenyls, per- and polyfluoroalkyl substances, or combinations thereof.

7. The method of claim 1, wherein the treatment methodology administered upon the at least a portion of soil comprises the application of a treatment additive to the at least a portion of soil; wherein the treatment additive is selected from an adsorbent, a permeability modifier, a chemical species, a processing agent, a microorganism or combinations thereof.

8. The method of claim 7, wherein the cumulative weight of the adsorbents that are applied to the at least a portion of soil ranges from 0.01-25% of the soil weight.

9. The method of claim 7, wherein the adsorbents are selected from activated carbon, modified clay minerals, ionic exchange resins, cyclodextrin polymers, zeolites, and combinations thereof.

10. The method of claim 1, wherein the treatment methodology administered upon the at least a portion of soil is selected from thermal desorption, thermal destruction, sonolysis, photocatalysis, soil washing, soil rinsing, soil ball milling, soil flushing or combinations thereof.

11. A method of establishing a micron-scale adsorbent barrier at an interface defining a volume of treatment containing soil, the interface further defining a boundary between the soil contained in the volume of treatment and surrounding soil, the method comprising a step of emplacing a layer of micron-sized adsorbents on at least a portion of the interface.

12. The method of claim 11, wherein the emplacement step is performed via spraying, auger mixing, injection or combinations thereof.

13. The method of claim 11, wherein the layer of micron-sized adsorbents has a thickness ranging from 0.001-100 kg/m².

14. The method of claim 11, wherein the micron-sized adsorbents are selected from: activated carbon, modified clay minerals, ionic exchange resins, cyclodextrin polymers, zeolites, or combinations thereof.

15. The method of claim 11, wherein the particles of the micron-sized adsorbents are less than 20 microns in diameter.

16. The method of claim 15, wherein the particles of the micron-sized adsorbents have a D90 value of 10 microns or less.

17. The method of claim 11, wherein the layer of the micron-sized adsorbents is emplaced by applying a suspension of the micron-sized adsorbents into at least a portion of the interface.

18. The method of claim 17, wherein the micron-sized adsorbents range from 0.001-69% by weight of solid component of the suspension.

19. The method of claim 11, the method further comprising a step of applying adsorbents to at least a portion of soil contained in the volume of treatment such that at least a portion of the adsorbents are placed on at least a portion of the interface.

20. The method of claim 19, wherein at least some of the micron-sized adsorbents and at least some of the adsorbents are emplaced at the same portion of the interface.
